(19) United States
(12) Patent Application Publication
(10) Pub. No.: US 2017/0237769 A1
(43) Pub. Date: Aug. 17, 2017

(54) PACKET TRANSFER METHOD AND PACKET TRANSFER APPARATUS

(71) Applicant: FUJITSU LIMITED, Kawasaki-shi (JP)

(72) Inventors: SHIGEMORI OOKAWA, Hakusan (JP); Yoshinari Akakura, Oyabe (JP); Takanori Sasaki, Takaoka (JP); Takuya OKAMOTO, Kanazawa (JP); Tadayuki Nishihashi, Kanazawa (JP); TAKUYA MAEDA, Kanazawa (JP)

(73) Assignee: FUJITSU LIMITED, Kawasaki-shi (JP)

(21) Appl. No.: 15/419,988

(22) Filed: Jan. 30, 2017

(30) Foreign Application Priority Data
Feb. 12, 2016 (JP) 2016-025268

(51) Int. Cl. H04L 29/06; H04L 12/26; H04L 12/721

(52) U.S. Cl. CPC H04L 63/1458; H04L 45/26; H04L 43/16; H04L 63/0236; H04L 69/324

(57) ABSTRACT

A packet transfer method includes requesting a terminal apparatus for a physical address corresponding to a logical address of a transmission source of a packet; determining legality of a correspondence relationship between the physical address and the logical address by comparing a physical address indicated by a response from the terminal apparatus with the physical address of the transmission source of the packet; storing a first set of the physical address of the transmission source and the logical address of the transmission source of the packet, when it is determined that the correspondence relationship is legal; when a new packet is received, determining whether a second set of a physical address of a transmission source and a logical address of the transmission source of the new packet coincides with the first set; and transferring the new packet, when it is determined that the second set coincides with the first set.

### CROSS-REFERENCE TO RELATED APPLICATION

This application is based upon and claims the benefit of priority of the prior Japanese Patent Application No. 2016-025268, filed on Feb. 12, 2016, the entire contents of which are incorporated herein by reference.

### FIELD

The present embodiment relates to a packet transfer method and a packet transfer apparatus.

### BACKGROUND

A layer 2 switch includes a plurality of ports that perform transmission and reception of a packet to and from a terminal or the like and transfers a packet between the ports. The layer 2 switch performs media access control (MAC) address learning to register the number of a port at which a packet is received and a transmission source MAC address of the packet in an associated relationship with each other into a MAC address table. The layer 2 switch determines a port of a transfer destination of a packet based on the MAC address table. This operation is called “filtering.”

When a new MAC address is registered into the MAC address table or when registration contents are changed, the layer 2 switch transmits the pertinent packet from ports other than the port of the reception source. This operation is called “flooding.”

As a denial of service (DoS) attack that utilizes the MAC address learning, there is a MAC flooding attack. In the MAC flooding attack, a malicious user spoofs the MAC address of an own terminal. Then, the malicious user transmits a great number of packets (hereinafter referred to as “illegal packet”) in each of which a false MAC address is indicated as the transmission source to the layer 2 switch.

The layer 2 switch performs flooding every time a MAC address of an illegal packet is registered into the MAC address table. Accordingly, the load of the process increases and the transfer speed of packets decreases. Further, the capacity of the MAC address table is limited. Therefore, if the registration number of MAC addresses reaches its upper limit, a MAC address registered already in the MAC address table is overwritten with the MAC address of an illegal packet. As a result, a packet of a different user is not transferred any more to a correct port originally registered in the MAC address table.

In addition, when the layer 2 switch receives a packet of a different user, it re-registers the MAC address of the received packet into the MAC address table. At this time, since the packet of the different user is flooded, the packet is transmitted also to the terminal of the malicious user. Accordingly, the malicious user may illegally acquire the packet destined for a different user.

In Japanese Laid-open Patent Publication No. 2007-36374, a technology is disclosed that communication is blocked by filtering based on an Internet protocol (IP) address against a client terminal that is illegally accessing to a network.

Against MAC flooding attacks, the layer 2 switch may monitor for each port, for example, the frequency of change of a port number corresponding to a MAC address registered in the MAC address table. Then, the layer 2 switch may close a port with regard to which the frequency exceeds a given threshold value. Consequently, the layer 2 switch may prevent reception of an illegal packet.

However, if a port is closed, since communication of some other user coupled to the port as well as of a malicious user is difficult, the influence on the network may be significant. Taking the foregoing into consideration, it is desirable to be able to defend against MAC flooding attacks without performing port closure.

### SUMMARY

According to an aspect of the embodiment, a packet transfer method executed by a processor included in a packet transfer apparatus that receives a packet from a terminal apparatus and transfers the packet, the packet transfer method includes: requesting the terminal apparatus for a physical address corresponding to a logical address of a transmission source of the packet; determining legality of a correspondence relationship between the physical address of the transmission source and the logical address of the transmission source of the packet by comparing a physical address indicated by a response from the terminal apparatus with the physical address of the transmission source of the packet; storing a first set of the physical address of the transmission source and the logical address of the transmission source of the packet, when it is determined that the correspondence relationship is legal; when a new packet is received, determining whether a second set of a physical address of a transmission source and a logical address of the transmission source of the received new packet coincides with the first set; and transferring the received new packet, when it is determined that the second set coincides with the first set.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of MAC address learning;

FIG. 2 is a view illustrating an example of filtering;

FIG. 3 is a view illustrating an example of a MAC flooding attack;

FIG. 4 is a view illustrating an example of re-registration of a MAC address;

FIG. 5 is a view illustrating an example of a determination method of an illegal packet;

FIG. 6 is a block diagram depicting an example of a layer 2 switch;

FIG. 7 is a view illustrating an example of a MAC address table, a monitoring table and a filter table;

FIG. 8 is a flow chart illustrating an example of a process of a mode controlling unit;

FIG. 9 is a flow chart illustrating an example of a process of a layer 2 switch chip;

FIG. 10 is a flow chart illustrating an example of operation in a restriction mode;

FIG. 11 is a sequence diagram illustrating an example of a process for a packet from a normal user;

FIG. 12 is a sequence diagram illustrating another example of a process for a packet from a normal user; and

FIG. 13 is a sequence diagram illustrating an example of a process for a packet from a malicious user.

### DESCRIPTION OF EMBODIMENT

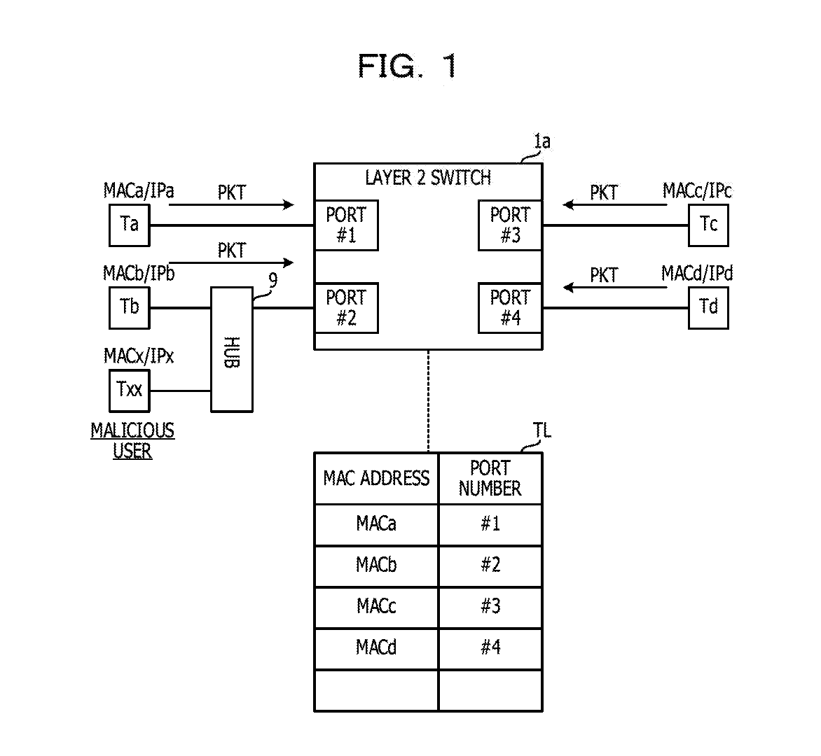

FIG. 1 illustrates an example of MAC address learning. A layer 2 switch 1a is an example of a packet transfer apparatus and receives and transfers a packet. On the layer 2 switch 1a, ports #1 to #4 for transmitting and receiving a packet PKT are provided as an example. The ports #1 to #4 are configured, for example, from a physical layer (PHY)/MAC chip or the like. As a packet, an Ethernet (registered trademark) frame is available. However, the packet is not limited to this.

The port #1 is coupled to a terminal Ta through a local area network (LAN) cable or the like, and the port #2 is coupled to terminals Tb and Txx through a LAN cable or the like. The port #3 is coupled to a terminal Tc through a LAN cable or the like, and the port #4 is coupled to a terminal Td through a LAN cable or the like. The terminals Tb and Txx are coupled to the common port #2, for example, through a hub (HUB) 9. The terminals Ta to Td and Txx may be coupled to the layer 2 switch 1a through a wireless LAN such as wireless fidelity (Wi-Fi) (registered trademark).

The terminals Ta to Td and Txx individually are, for example, a computer and communicate with each other through the layer 2 switch 1a. The terminals Ta to Td and Txx include individual MAC addresses “MACa” to “MACd” and “MACx” and individual IP addresses “IPa” to “IPd” and “IPx,” respectively. The MAC addresses “MACa” to “MACd” and “MACx” are physical addresses of six bytes applied upon manufacture of the terminals Ta to Td and Txx, respectively. In the present example, the MAC addresses of the terminals Ta to Td and Txx are represented by symbols “MACa” to “MACd” and “MACx,” respectively, for the convenience of description.

The IP addresses “IPa” to “IPd” and “IPx” are logical addresses in a network applied, for example, from a dynamic host configuration protocol (DHCP) server (not depicted) or the like. The IP addresses “IPa” to “IPd” and “IPx” are, in the case of Internet protocol version 4 (IPv4), data of 32 bits. The IP addresses “IPa” to “IPd” and “IPx” are, in the case of Internet protocol version 6 (IPv6), data of 128 bits. In the present example, the IP addresses of the terminals Ta to Td and Txx are indicated by “IPa” to “IPd” and “IPx,” respectively, for the convenience of description.

The layer 2 switch 1a includes a MAC address table TL in which MAC addresses and port numbers (#1 to #4) are registered in an associated relationship with each other. Here, each port number is an example of an identifier of a port. The layer 2 switch 1a performs MAC address learning from packets PKT received through the ports #1 to #4 from the terminals Ta to Td, respectively.

The layer 2 switch 1a registers, for example, the transmission source MAC address (source address, SA) “MACa” of the packet PKT received through the port #1 from the terminal Ta into the MAC address table TL in an associated relationship with the port number #1. MAC address learning is performed similarly from packets PKT received from the other terminals Tb to Td. The terminal Txx is operated by a malicious user who performs MAC flooding attacks, and it is assumed that, MAC address learning of the terminal Txx is not performed until after a MAC flooding attack is performed.

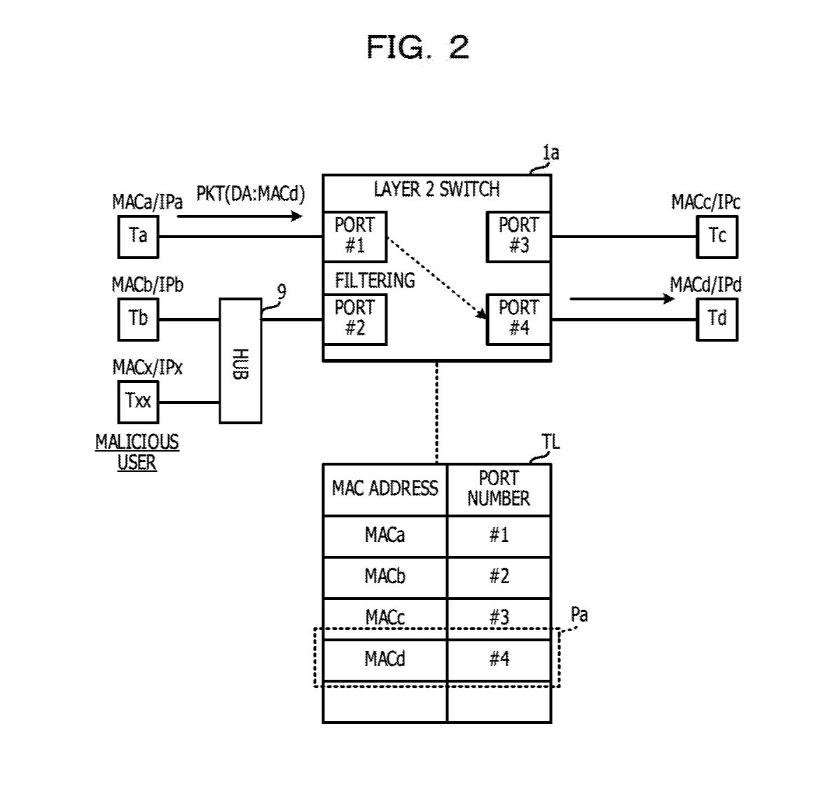

FIG. 2 illustrates an example of filtering. The layer 2 switch 1a transfers a packet PKT between the ports #1 to #4 based on the MAC address table TL. For example, the layer 2 switch 1a determines a port of a transfer destination of a packet based on the MAC address table.

It is assumed that the layer 2 switch 1a receives, for example, from the terminal Ta, a packet PKT in which the destination MAC address (destination address, DA) is the MAC address “MACd” of the terminal Td. The layer 2 switch 1a refers to the MAC address table TL to search for the port number #4 corresponding to the MAC address “MACd” (refer to symbol Pa). Therefore, the layer 2 switch 1a transfers the packet PKT received form the terminal Ta to the terminal Td through the port #4 (refer to an arrow mark of a broken line). The layer 2 switch 1a performs filtering in this manner.

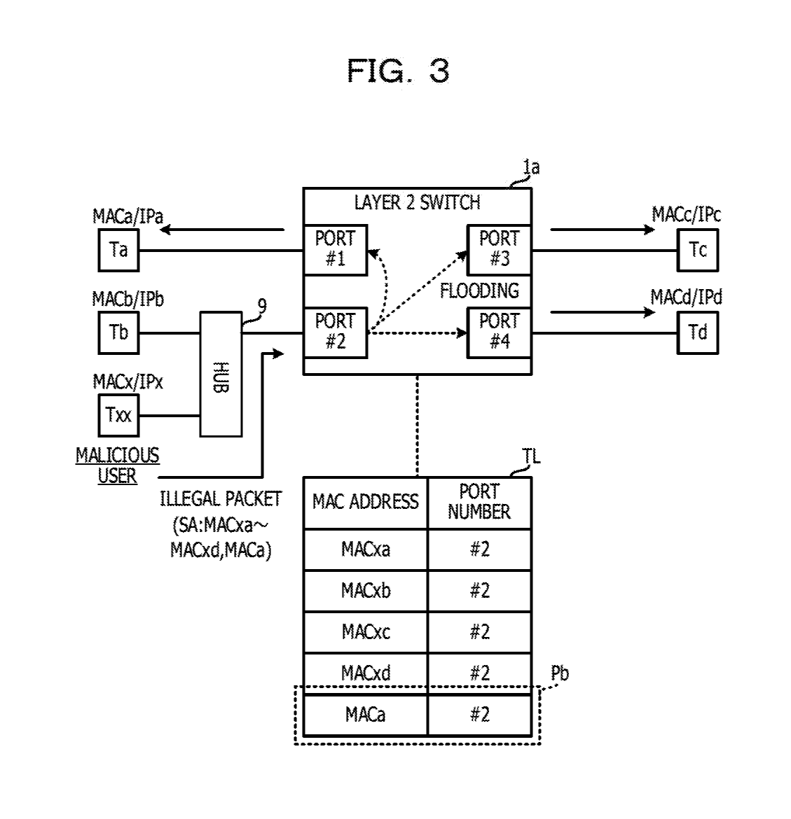

FIG. 3 illustrates an example of a MAC flooding attack. The malicious user spoofs a MAC address “MACx” of the own terminal Txx. The malicious user transmits a large number of illegal packets in which false MAC addresses “MACxa” to “MACxd” and “MACa” are used as the SA to the layer 2 switch 1a.

The layer 2 switch 1a performs flooding every time any of the MAC addresses “MACxa” to “MACxd” and “MACa” of the illegal packets is registered into the MAC address table TL. Therefore, the load of processing increases and the transfer speed of a packet drops.

The capacity of the MAC address table TL is limited. Accordingly, if the registration number of MAC addresses reaches its upper limit, the MAC addresses “MACa” to “MACd” registered already in the MAC address table TL are overwritten with the MAC addresses “MACxa” to “MACxd” and “MACa” of the illegal packets. As a result, a packet of a different user is not transferred to a correct port registered originally in the MAC address table TL.

For example, since the terminal Txx has transmitted an illegal packet in which the MAC address “MACa” same as that of the terminal Ta is used as the SA, the port number corresponding to the MAC address “MACa” registered already in the MAC address table TL is rewritten from #1 to #2 (refer to symbol Pb). For example, the port number corresponding to the MAC address “MACa” in the MAC address table TL is changed. Therefore, a packet in which the MAC address “MACa” of the terminal Ta is used as the DA is transferred to the terminal Txx instead of the terminal Ta.

Further, when the layer 2 switch 1a receives a packet of the terminal Ta, it re-registers the MAC address “MACa” of the terminal Ta into the MAC address table TL.

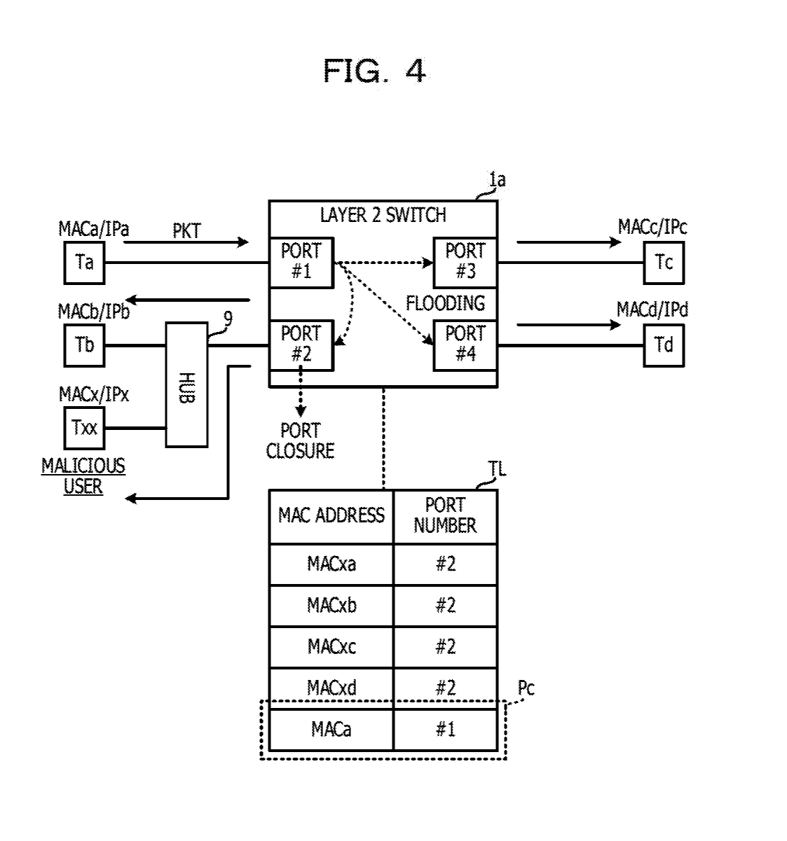

FIG. 4 illustrates an example of re-registration of a MAC address. The layer 2 switch 1a receives a packet PKT in which the legal MAC address “MACa” that is not false is used as the SA from the terminal Ta. In this case, the layer 2 switch 1a rewrites the port number corresponding to the MAC address “MACa” registered already in the MAC address table TL from #2 to #1 (refer to symbol Pc).

At this time, since the packet PKT of the terminal Ta is flooded to the ports #2 to #4, it is transmitted also to the terminal Txx of the malicious user. Accordingly, the malicious user may illegally acquire a packet destined for a different person.

Against the MAC flooding attack, the layer 2 switch 1a monitors, for example, the frequency of change of a port number corresponding to a MAC address registered in the MAC address table TL for each of the ports #1 to #4. Then, the layer 2 switch 1a closes a port whose frequency exceeds a given threshold value. Consequently, the layer 2 switch 1a may reject reception of an illegal packet.

In the MAC address table TL of the present example, the port number corresponding to the MAC address “MACa” is changed between #1 and #2 as described above. Therefore, when the changing time number of a port number exceeds the given threshold value, the layer 2 switch 1a closes the pertinent port #2. Consequently, transmission and reception of a packet by the port #2 are difficult.

However, if the port #2 is closed, the influence of this on the network is significant because communication of the terminal Tb of the different user coupled to the port #2 as well as of the terminal Txx of the malicious user is difficult.

Accordingly, the layer 2 switch 1a in the working example requests the terminals Ta to Td and Txx for a MAC address corresponding to the transmission source IP address of packets received from the terminals Ta to Td and Txx. Then, the laser 2 switch 1a determines based on a response to the request whether or not the transmission source MAC address of the packet is legal. Then, the layer 2 switch 1a registers, in response to a result of the determination, the set of the transmission source MAC address and the transmission source IP address into a filter table hereinafter described. Then, the layer 2 switch 1a defends against MAC flooding attacks without closing a port by discarding or transferring a packet based on the filter table.

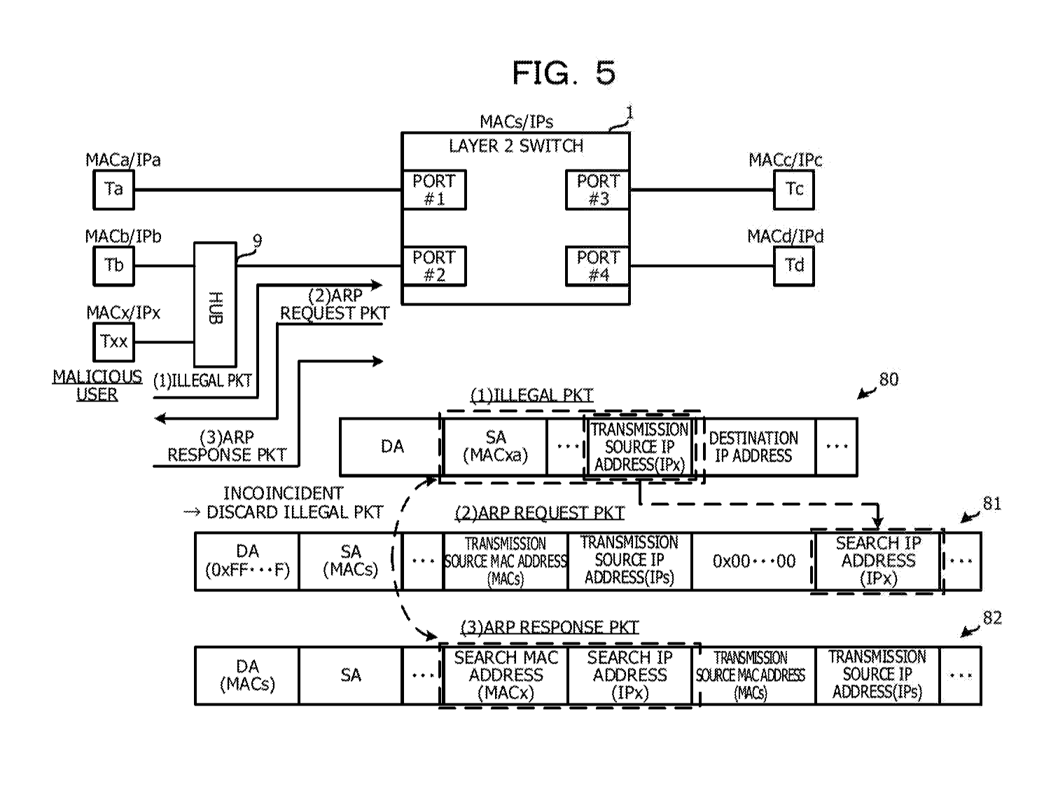

FIG. 5 illustrates an example of a determination method of an illegal packet. In FIG. 5, components and information similar to those in FIGS. 1 to 4 are represented by same symbols, and overlapping description of them is omitted herein. In this example, it is assumed that the MAC address of a layer 2 switch 1 is “MACs” and the IP address of the layer 2 switch 1 is “IPs.”

The layer 2 switch 1 in the working example is an example of a packet transfer apparatus. Similarly to the layer 2 switch 1a described above, the layer 2 switch 1 receives a packet from any of the terminals Ta to Td and Txx and transfers the packet. The layer 2 switch 1 monitors the changing time number of a port number corresponding to a MAC address in the MAC address table TL for each of the ports #1 to #4. The layer 2 switch 1 operates in a “normal mode” when the changing time number of a port number is equal to or smaller than a given threshold value. On the other hand, when the changing time number of a port number exceeds the given threshold value, the layer 2 switch 1 operates in a “restriction mode.” In the normal mode, the layer 2 switch 1 performs the operation described hereinabove with reference to FIGS. 1 to 4. On the other hand, in the restriction mode, the layer 2 switch 1 determines an illegal packet and restricts MAC address learning based on the illegal packet and transfer of the illegal packet as hereinafter described.

The layer 2 switch 1 registers the transmission source MAC address (SA) and the transmission source IP address of a legal packet, not an illegal packet, from among packets received from the terminals Ta to Td and Txx into a filter table hereinafter described. The layer 2 switch 1 determines whether or not a packet with regard to which an appropriate entry is not found in the filter table is an illegal packet. In the example described below, a case is described in which an illegal packet is transmitted from the terminal Txx of the malicious user to the layer 2 switch 1.

If the layer 2 switch 1 receives a packet indicated by symbol 80 (refer to (1)), it stores the packet into a packet buffer. This packet is an illegal packet (illegal PKT) in which the false MAC address “MACxa” is used as the SA and the true IP address “IPx” is used as the transmission source IP address. At this stage, the layer 2 switch 1 may not be able to decide whether or not the received packet is an illegal packet.

Then, the layer 2 switch 1 generates an address resolution protocol (ARP) request packet (namely, an ARP request) in which the transmission source IP address of the illegal packet is used as a search IP address (refer to (2)). The ARP request packet is a packet for requesting for a MAC address corresponding to a certain IP address. In the present example, the IP address and the MAC address are represented as search IP address and search MAC address, respectively.

In the ARP request packet, as denoted by symbol 81, the broadcast address “0xFF . . . FF” (0x is a hexadecimal notation) is used as the DA and the MAC address “MACs” of the layer 2 switch 1 is used as the SA. In a region for a transmission source MAC address and in a region for a transmission source IP address of the ARP request packet, the MAC address “MACs” and the IP address “IPs” of the layer 2 switch 1 are housed, respectively. In a region immediately preceding to the search IP address, a fixed value “0x00 . . . 00” is housed in place of the search MAC address.

The ARP request packet includes a DA of broadcast. Because of this, the ARP request packet is transmitted from all ports #1 to #4. However, in FIG. 5, only the ARP request packet transmitted to the terminal Txx is depicted.

When the terminal Txx receives the ARP request packet, it returns an ARP response packet (namely, an ARP reply) to the ARP request packet (refer to (3)). At this time, the terminal Txx may not be able to generate an ARP response packet for the notification of a false MAC address. Thereby in the ARP response packet, the true MAC address “MACx” of the terminal Txx is inserted into the region for a search MAC address as denoted by symbol 82.

For example since the terminal Txx may not be able to spoof the MAC address in response to the ARP request packet, it notifies the layer 2 switch 1 of the legal MAC address (namely, the true MAC address) “MACx.” The ARP response packet includes the MAC address “MACs” of the layer 2 switch 1 as the DA, and in the region for the search IP address, the IP address “IPx” same as the search IP address of the ARP request packet is inserted.

When the layer 2 switch 1 receives the ARP response packet, it compares the search MAC address “MACx” and the search IP address “IPx” of the ARP response packet with the transmission source MAC address (SA) “MACxa” and the transmission source IP address “IPx” of the illegal packet received from the terminal Txx. As a result of the comparison, the layer 2 switch 1 finds that, although the IP addresses coincide with each other, the search MAC address “MACx” and the transmission source MAC address “MACxa” do not coincide with each other. Therefore, the layer 2 switch 1 regards the SA of the received packet as a false MAC address and determines the packet as an illegal packet and discards the packet.

Consequently, the layer 2 switch 1 may avoid MAC address learning based on an illegal packet and transfer of the illegal packet without closing the port #2. In the following, a configuration of the layer 2 switch 1 is described.

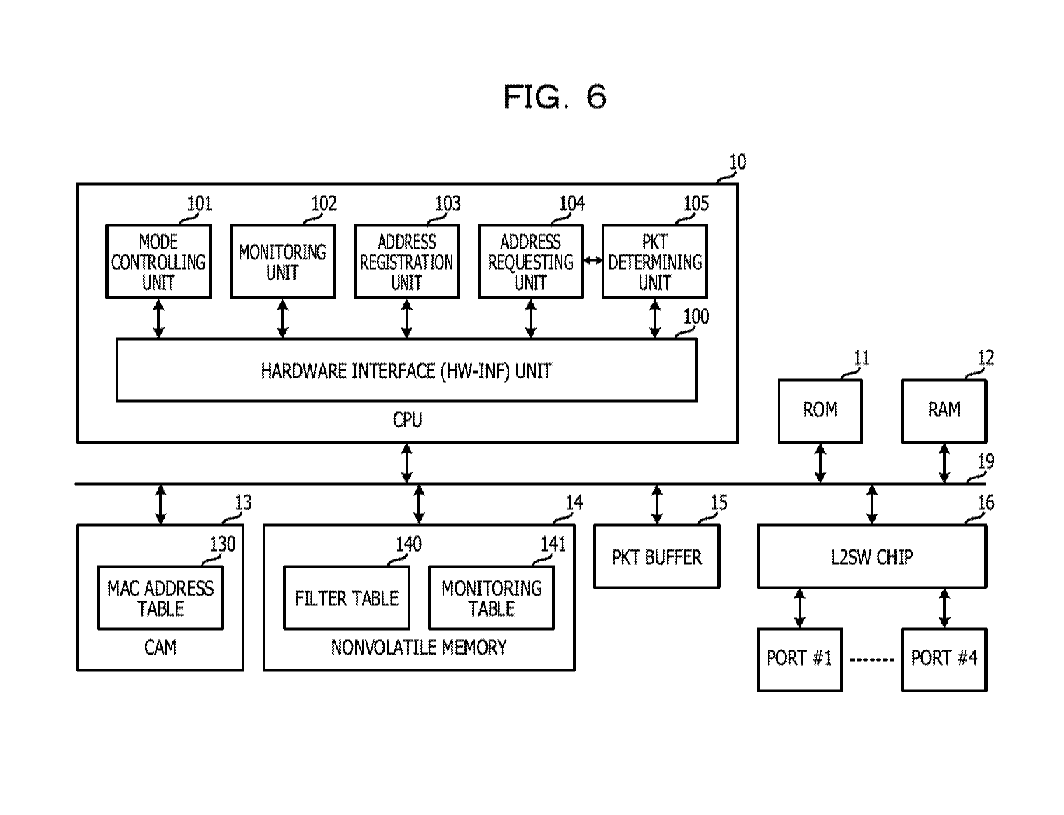

FIG. 6 is a block diagram depicting an example of a layer 2 switch. Incidentally, the layer 2 switch illustrated in FIG. 6 may be the layer 2 switch 1 illustrated in FIG. 5. The layer 2 switch 1 includes a central processing unit (CPU) 10, a layer 2 switch (L2SW) chip 16, a read only memory (ROM) 11 and a random access memory (RAM) 12. The layer 2 switch 1 further includes a content addressable memory (CAM) 13, a nonvolatile memory 14, a packet (PKT) buffer 15 and ports #1 to #4.

The CPU 10 and the L2SW chip 16 are coupled to the ROM 11, RAM 12, CAM 13, nonvolatile memory 14 and packet buffer 15 by a bus 19 such that a signal may be inputted and outputted between them. Although the CPU 10 and the L2SW chip 16 are coupled to the bus 19 in common, the coupling scheme is not limited to this, and the CPU 10 and the L2SW chip 16 may be coupled to buses different from each other. In this case, the CPU 10 and the L2SW chip 16 may communicate with each other through a memory in common coupled to the respective buses.

The ROM 11 has a program for driving the CPU 10 stored therein. The RAM 12 functions as a working memory of the CPU 10. The ports #1 to #4 are coupled to the L2SW chip 16 and individually transmit and receive packet to and from the respective terminals Ta to Td and Txx.

The L2SW chip 16 is configured from hardware such as an integrated circuit and is coupled to the ports #1 to #4. The L2SW chip 16 is an example of a packet processing unit and performs a transfer process of a packet between the ports #1 to #4 and so forth. Although the L2SW chip 16 performs packet transfer in accordance with a cut-through method as an example, the transfer is not limited to this.

The L2SW chip 16 cooperates with the CPU 10 to perform the processes described hereinabove with reference to FIG. 5. The configuration of the L2SW chip 16 is not limited to hardware and may be formed as software to be executed by the CPU 10.

The CPU 10 forms, when it reads in a program from the ROM 11, a hardware interface (HW-INF) unit 100, a mode controlling unit 101, a monitoring unit 102, an address registration unit 103, an address requesting unit 104 and a packet (PKT) determination unit 105 as functions. The CAM 13 is an example of a second storage unit and stores a MAC address table 130. The MAC address table 130 is an example of an address table and corresponds to the MAC address table TL illustrated in FIGS. 1 to 4.

The nonvolatile memory 14 is an example of a first storage unit (storage unit) and stores a filter table 140 and a monitoring table 141. As the nonvolatile memory 14, for example, an erasable programmable ROM (EPROM) is available. The packet buffer 15 is configured, for example, from a memory and houses a packet. The L2SW chip 16 houses, in the restriction mode, a packet an entry of which the filter table 140 does not have into the packet buffer 15.

The HW-INF unit 100 mediates communication between the components 101 to 105 and the L2SW chip 16. The HW-INF unit 100 converts, for example, the format of messages such as various instructions, notifications and responses between the components 101 to 105 and the L2SW chip 16.

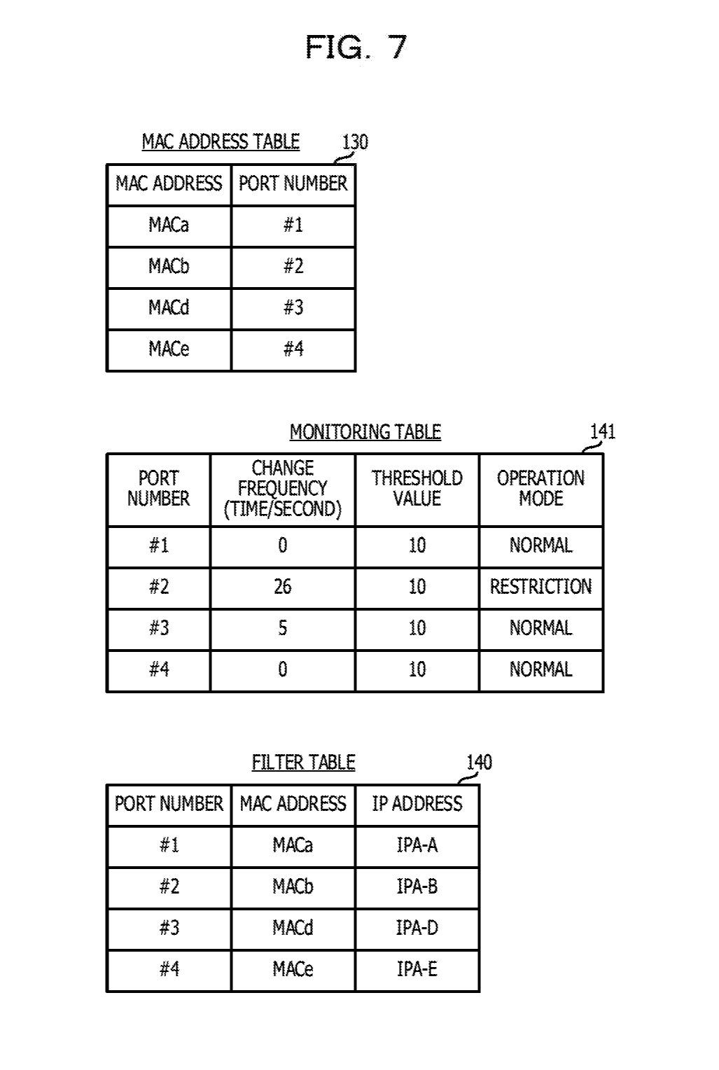

The address registration unit 103 is an example of a registration unit and registers a port number of one of the ports #1 to #4, at which a packet is received, and the SA of the packet in an associated relationship with each other into the MAC address table 130 as described with reference to FIG. 1. FIG. 7 illustrates an example of a MAC address table. Incidentally, the MAC address table illustrated in FIG. 7 may be the MAC address table 130 illustrated in FIG. 6. The configuration of the MAC address table 130 is such as described hereinabove. The address registration unit 103 performs a registration process of the MAC address table 130 in accordance with an instruction from the L2SW chip 16.

In the normal mode, when the L2SW chip 16 receives a packet, it searches for the SA of the packet from the MAC address table 130. If a result of the search indicates that the pertinent MAC address is not registered as yet, the L2SW chip 16 instructs the address registration unit 103 to register the SA of the packet. Also where the pertinent MAC address is registered already, if the port number corresponding to the SA in the MAC address table 130 is different from the port number of one of the ports #1 to #4 at which the packet has been received, the L2SW chip 16 instructs the address registration unit 103 to change the port number registered in the MAC address table 130 to the pertinent port number.

In the normal mode, the L2SW chip 16 searches for the DA of the packet from within the MAC address table 130. If a result of the search indicates that the pertinent DA is registered already, the L2SW chip 16 transfers the packet from one of the ports #1 to #4 which has a port number corresponding to the DA. If the pertinent DA is not registered as yet, the L2SW chip 16 performs flooding of the packet.

On the other hand, in the restriction mode, when the L2SW chip 16 receives a packet, if it is determined that the packet is an illegal packet, the L2SW chip 16 does not perform such instruction of MAC address learning and a transfer process of a packet as described above. If it is determined that the packet is a legal packet or if an entry of the packet exists in the filter table 140, the L2SW chip 16 performs instruction of MAC address learning and a transfer process of the packet. Determination of whether the received packet is legal or illegal is made by the packet determination unit 105 based on an ARP response packet.

The monitoring unit 102 monitors the frequency of change of a port number corresponding to a MAC address of a packet registered in the MAC address table 130. For example, if the port number corresponding to the MAC address “MACa” is changed from #1 to #2 and then from #2 to #1 as in the MAC address table TL exemplified in FIGS. 1 to 4, the monitoring unit 102 counts the changing time number of a port number as twice. The counted changing time number is reset to 0 after it is read out periodically by the mode controlling unit 101, whereby the counted changing time number is treated as a frequency of change.

The monitoring unit 102 detects a change of a port number by periodically accessing the MAC address table 130 and counts up the frequency of change recorded in the monitoring table 141.

FIG. 7 illustrates an example of a monitoring table. Incidentally, the monitoring table illustrated in FIG. 7 may be the monitoring table 141 illustrated in FIG. 6. In the monitoring table 141, a change frequency (time/second), a threshold value for the change frequency and an operation mode of the layer 2 switch 1 are recorded for each port number. In the present example, the monitoring unit 102 counts the changing time number of a port number for each of the ports #1 to #4. However, the counting is not limited this, and the changing time number of a port number regarding all ports #1 to #4 may be counted.

The changing time number is registered as a change frequency. However, the changing time number is reset periodically (in the present example, after every one second) by the mode controlling unit 101 as described hereinabove. The threshold value for the change frequency may be a fixed value or may be a value settable from the outside.

The mode controlling unit 101 periodically reads out the change frequency and compares the change frequency with the threshold value therefor. The mode controlling unit 101 changes over the operation mode of the layer 2 switch 1 for each of the ports #1 to #4 in accordance with a result of the comparison. If the change frequency exceeds the threshold value, the mode controlling unit 101 changes over the operation mode to the restriction mode. At this time, the mode controlling unit 101 sets the operation mode for the pertinent one of the ports #1 to #4 of the monitoring table 141 to “restriction.”

The mode controlling unit 101 changes over the operation mode to the normal mode in response to an instruction from the outside when the change frequency becomes equal to or lower than the threshold value. At this time, the mode controlling unit 101 sets the operation mode for a pertinent one of the ports #1 to #4 of the monitoring table 141 to “normal.” When the operation mode is changed over, the mode controlling unit 101 notifies the L2SW chip 16, address requesting unit 104 and packet determination unit 105 of the changeover of the operation mode.

The address requesting unit 104 is an example of a requesting unit and requests the terminals Ta to Td and Txx for a MAC address corresponding to the destination IP address of the packet. For example, the address requesting unit 104 generates and transmits an ARP request packet described hereinabove with reference to FIG. 5. The ARP request packet is transmitted from all ports #1 to #4 through the L2SW chip 16.

In the restriction mode, when the L2SW chip 16 receives a packet having no entry in the filter table 140, it houses the packet into the packet buffer 15. The address requesting unit 104 generates an ARP request packet for the packet housed in the packet buffer 15. For example, the address requesting unit 104 generates an ARP request packet in which the destination IP address of the packet in the packet buffer 15 is used as the search IP address.

The address requesting unit 104 monitors reception of an ARP response packet that is a response to an ARP request packet. The address requesting unit 104 receives an ARP response packet from the L2SW chip 16 and outputs the ARP response packet to the packet determination unit 105. As described hereinabove, each of the terminals Ta to Td and Txx places, in response to an ARP request packet, not a false MAC address but a true MAC address into the ARP response packet and transmits the ARP response packet.

Therefore, the layer 2 switch 1 may acquire the true MAC address from any of the terminals Ta to Td and Txx. The address requesting unit 104 monitors reception of an ARP response packet using a timer or the like after it transmits the ARP request packet. If the address requesting unit 104 fails to receive an ARP response packet even after a given time elapses, it notifies the packet determination unit 105 of the failure.

Although, in the restriction mode, the address requesting unit 104 generates and transmits an ARP request packet, in the normal mode, the address requesting unit 104 does not perform generation and transmission of an ARP request packet. For example, if the change frequency monitored by the monitoring unit 102 exceeds the threshold value, the address requesting unit 104 transmits an ARP request packet to request any of the terminals Ta to Td and Txx for a MAC address corresponding to the transmission source IP address of the packet. Accordingly, when the layer 2 switch 1 is not coupled to the terminal Txx of the malicious user, the layer 2 switch 1 is free from performing a process for generation and transmission of an ARP request packet, thereby reducing the load on the layer 2 switch 1.

The packet determination unit 105 is an example of a determination unit. The packet determination unit 105 determines, based on responses of the terminals Ta to Td and Txx to a request of the address requesting unit 104, whether or not the transmission source MAC address of the packet, namely, the SA of the packet, is legal. For example, the packet determination unit 105 receives an ARP response packet transmitted from any of the terminals Ta to Td and Txx to the ARP request packet. Then, the packet determination unit 105 compares the search MAC address and the search IP address in the ARP response packet with the SA and the transmission source IP address of the packet housed already in the packet buffer 15, respectively. For example, the packet determination unit 105 compares the search MAC address indicated by the ARP response packet and the SA of the packet with each other.

If a result of the comparison indicates that the search MAC address and the search IP address in the ARP response packet coincide with the SA and the transmission source IP address of the packet, respectively, the packet determination unit 105 determines that the SA of the packet received from any of the terminals Ta to Td and Txx is a true MAC address. On the other hand, if the search MAC address and the search IP address in the ARP response packet do not coincide with the SA and the transmission source IP address of the packet respectively, the packet determination unit 105 determines that the SA is a false MAC address. In this manner, the packet determination unit 105 determines the legality of the correspondence relationship of the SA and the transmission source IP address of the packet in response to a result of the comparison described above.

For example, if the MAC address indicated by the ARP response packet coincides with the SA of the received packet, the packet determination unit 105 determines that the correspondence relationship between the SA and the transmission source IP address is legal. On the other hand, if the MAC address indicated by the ARP response packet does not coincide with the SA of the received packet, the packet determination unit 105 determines that the correspondence relationship between the SA and the transmission source IP address is illegal. Accordingly, the layer 2 switch 1 may detect the terminal Txx of the malicious user from which the packet of the false SA has been transmitted from the MAC address indicated by the ARP response packet.

If the packet determination unit 105 receives a notification that an ARP response packet is not received from the address requesting unit 104, the packet determination unit 105 determines that the received packet is an illegal packet. For example, if the packet determination unit 105 does not receive an ARP response packet from the terminal Txx, it determines that the correspondence relationship between the SA and the transmission source IP address of the packet is illegal.

This is because there is the possibility that a malicious user may take measures for suppressing an ARP response packet from being transmitted from the terminal Txx in order to conceal that a packet of a false SA is transmitted. Also in such a case, the packet determination unit 105 may detect the terminal Txx of the malicious user from which the packet of the false SA has been transmitted from the fact that an ARP response packet is not received. The packet determination unit 105 notifies the L2SW chip 16 of a result of the determination of the packet.

The L2SW chip 16 discards or transfers the packet in response to a result of the determination by the packet determination unit 105. For example, if the result of the determination indicates that the packet is illegal, the L2SW chip 16 discards the packet. If the packet is legal, the L2SW chip 16 transfers the packet. Further, when the packet is legal, the L2SW chip 16 instructs the address registration unit 103 to perform MAC address learning by the packet. In the following description, a packet that is not an illegal packet is referred to as “legal packet.”

Therefore, the layer 2 switch 1 may prevent MAC address learning and transfer of an illegal packet based on the illegal packet. Accordingly, the layer 2 switch 1 may defend against MAC flooding attacks without performing port closure.

The L2SW chip 16 registers, for each pertinent port number, the SA and the transmission source IP address of a legal packet in an associated relationship with each other into the filter table 140. For example, the L2SW chip 16 registers the SA and the transmission source IP address of a packet into the filter table 140 in response to a result of the determination by the packet determination unit 105.

FIG. 7 illustrates an example of a filter table. Incidentally, the filter table illustrated in FIG. 7 may be the filter table 140 illustrated in FIG. 6. In the filter table 140, the SA and the transmission source IP address of a legal packet are registered as a set of a MAC address and an IP address for each port number. For example, a filter table 140 in which MAC addresses and logical addresses are registered in an associated relationship with each other is stored in the nonvolatile memory 14.

If a packet is newly received in the restriction port, the L2SW chip 16 compares the set of the SA and the transmission source IP address of the packet with the set of a MAC address and an IP address registered in the filter table 140. Then, the L2SW chip 16 discards or transfers the packet in response to a result of the comparison. For this, the layer 2 switch 1 may defend against MAC flooding attacks using the filter table 140.

For example, when a new packet is received, if the set of the SA and the transmission source IP address of the packet coincides with the set of a MAC address and an IP address registered in the filter table 140, namely, if the filter table 140 includes an entry of the packet, the L2SW chip 16 transfers the packet. If the sets described above do not coincide with each other, since no determination has been made as yet for the packet, the L2SW chip 16 instructs the address requesting unit 104 to generate and transmit an ARP request packet.

Accordingly, the layer 2 switch 1 may eliminate the effort of a process for generating and transmitting an ARP request packet in regard to a packet that has been determined as a legal packet at least once by the packet determination unit 105. Naturally, layer 2 switch 1 is not limited to this and may generate and transmit an ARP request packet in regard to all received packets. The entry of the filter table 140 is erased, for example, when the operation mode of the layer 2 switch 1 returns to the normal mode from the restriction mode. Now, a process of the layer 2 switch 1 is described.

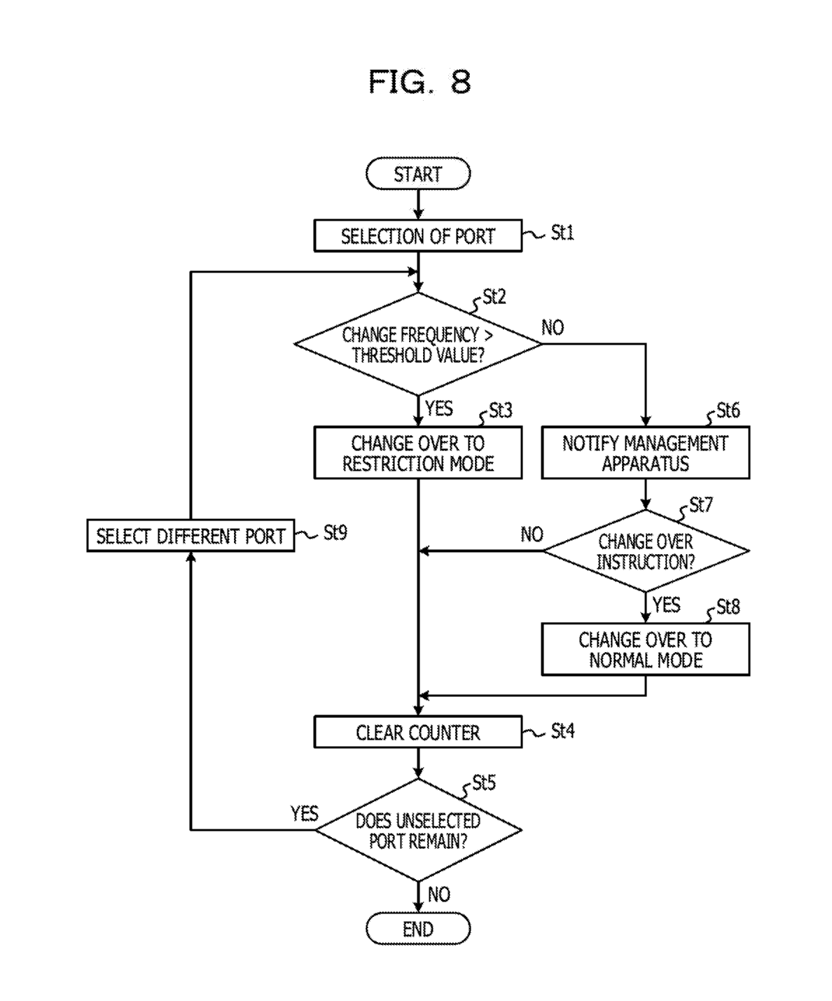

FIG. 8 is a flow chart illustrating an example of a process of a mode controlling unit. Incidentally, the mode controlling unit described with reference to FIG. 8 may be the mode controlling unit 101 illustrated in FIG. 6. The mode controlling unit 101 is activated, for example, in a cycle of one second and executes the following process.

The mode controlling unit 101 selects one of the ports #1 to #4 (St1). Then, the mode controlling unit 101 refers to the monitoring table 141 and compares the change frequency of the selected one of the ports #1 to #4 with a threshold value therefor (St2). Since the mode controlling unit 101 reads out the change frequency of the monitoring table 141 in a cycle of one second in this manner, the counter value of the change frequency is used as a change frequency of a unit of one second. There is no restriction to the reading out period of the counter value of the change frequency of the monitoring table 141.

If the change frequency exceeds the threshold value (Yes at St2), the mode controlling unit 101 changes over the operation mode of the layer 2 switch 1 to the restriction mode (St3). In the restriction mode, the address requesting unit 104 requests the terminals Ta to Td and Txx for a transmission source IP address corresponding to the SA of the received packet by transmission of an ARP request packet. However, in the normal mode, the address requesting unit 104 does not perform such request.

Accordingly, only when the change frequency is high, namely, only when a MAC flooding attack by a malicious user is suspected, an ARP request packet is transmitted from the selected one of the ports #1 to #4. On the other hand, in the normal mode in which the change frequency is low, the load of a transmission process of an ARP request packet is omitted.

Then, the mode controlling unit 101 clears the counter of the change frequency of the monitoring table 141 to zero (St4). Then, the mode controlling unit 101 determines whether or not there remains an unselected one of the ports #1 to #4 (St5). If there remains no unselected one of the ports #1 to #4 (No at St5), the mode controlling unit 101 ends the processing. If there remains an unselected one of the ports #1 to #4 (Yes at St5), the mode controlling unit 101 selects a different one of the ports #1 to #4 (St9) and executes the determination process at St2 again.

When the change frequency is equal to or lower than the threshold value (No at St2), the mode controlling unit 101 notifies a management apparatus of the layer 2 switch 1 of the fact (St6). The management apparatus may be, for example, one of the terminals Ta to Td or may be some other apparatus.

If a changing over instruction to the normal mode is not received from the management apparatus (No at St7), the mode controlling unit 101 executes the process at St4 described hereinabove. If a changing over instruction to the normal mode is received from the management apparatus (Yes at St7), the mode controlling unit 101 changes over the operation mode of the layer 2 switch 1 to the normal mode (St8) and executes the process at St4 described hereinabove. The process of the mode controlling unit 101 is executed in this manner.

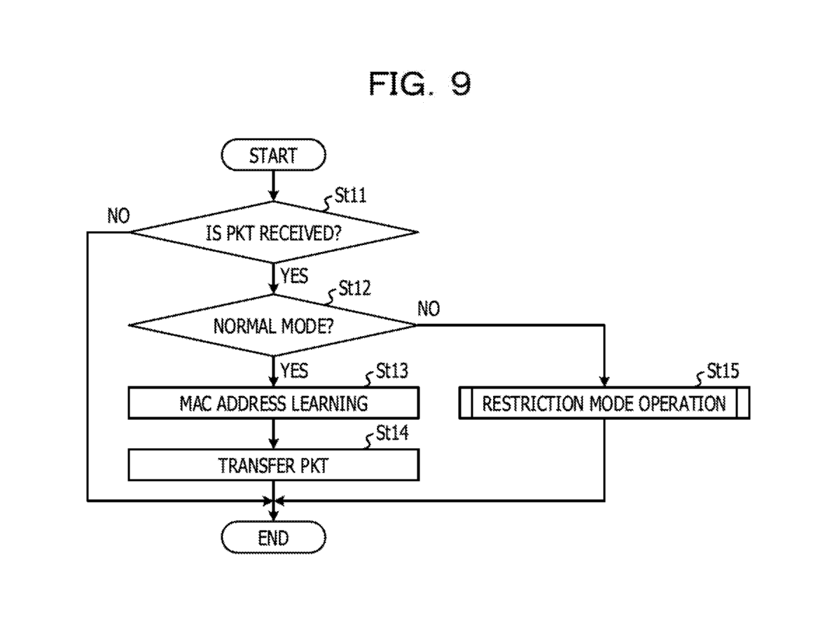

FIG. 9 is a flow chart illustrating an example of a process of a L2SW chip. Incidentally, the L2SW chip described with reference to FIG. 9 may be the L2SW chip 16 illustrated in FIG. 6. The present process is executed, for example, periodically.

The L2SW chip 16 determines whether or not a packet is received (St11). The L2SW chip 16 may decide whether or not a packet is received, for example, based on a reception notification of a packet from any of the ports #1 to #4. If no packet is received (No at St11), the L2SW chip 16 ends the processing.

If a packet is received (Yes at St11), the L2SW chip 16 determines which one of the normal mode and the restriction mode the operation mode is (St12). If the operation mode is the restriction mode (No at St12), the L2SW chip 16 performs operation of the restriction mode hereinafter described (St15) and ends the process.

If the operation mode is the normal mode (Yes at St12), the L2SW chip 16 performs the process for MAC address learning illustrated in FIG. 1 (St13). If the SA of the received packet is registered already in the MAC address table 130, the MAC address learning is not performed.

Subsequently, the L2SW chip 16 performs the transfer process of a packet illustrated in FIG. 2 (St14). Since the L2SW chip 16 transfers a packet, for example, in accordance with the cut-through method, it may transfer, in the normal mode, the packet at a high speed without housing the packet into the packet buffer 15. The layer 2 switch 1 is not limited to this and may house a packet into the packet buffer 15 independently of the operation mode in accordance with the store and forward method. The process of the L2SW chip 16 is executed in this manner.

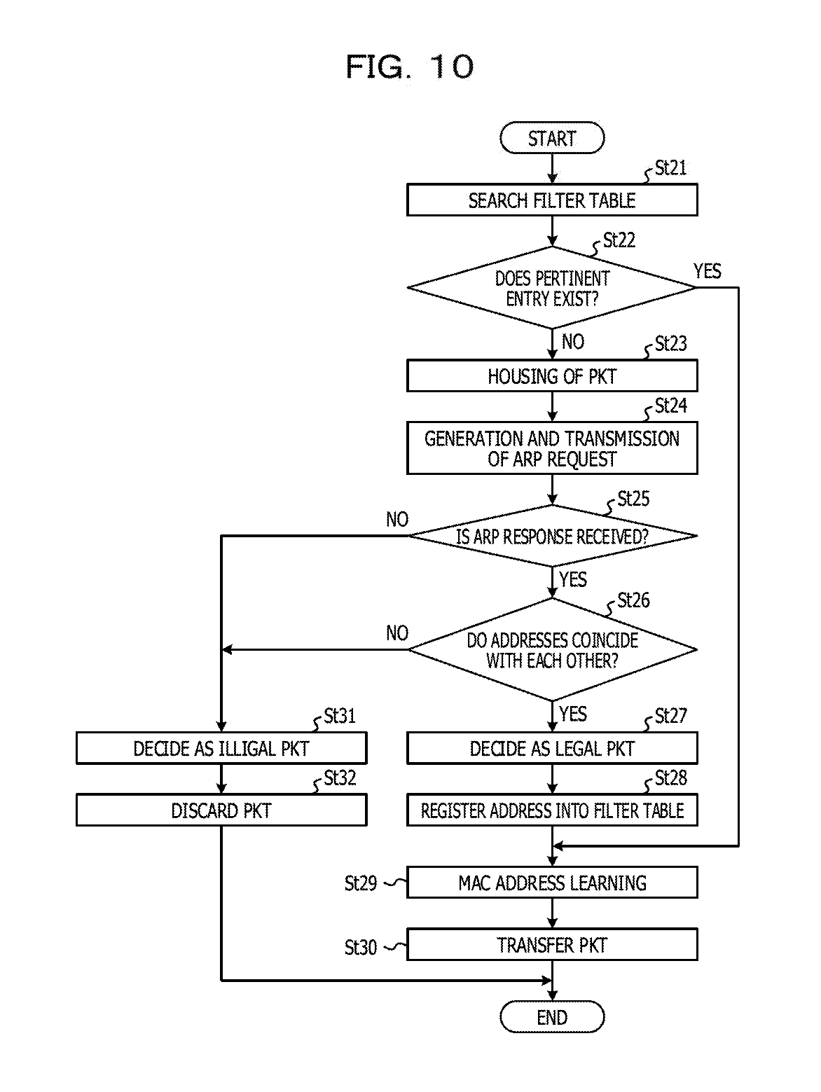

FIG. 10 is a flow chart illustrating an example of operation in a restriction mode. The present process is executed at St15 depicted in FIG. 9.

First, the L2SW chip 16 searches the filter table 140 based on the port number of one of the ports #1 to #4 at which a packet is received and the SA and the transmission source IP address of the packet (St21). Then, the L2SW chip 16 determines whether or not there exists an entry corresponding to the received packet in the filter table 140 (St22).

If an entry corresponding to the received packet exists (Yes at St22), the L2SW chip 16 performs the process for MAC address learning illustrated in FIG. 1 (St29). Subsequently, the L2SW chip 16 performs the transfer process of the packet illustrated in FIG. 2 (St30) and ends the process.

As described above, the L2SW chip 16 registers the SA and the transmission source IP address of a packet determined as a legal packet by the packet determination unit 105 into the filter table 140. Therefore, when a packet registered already in the filter table 140 is received, the L2SW chip 16 may omit the processes beginning with St23 hereinafter described.

If an entry corresponding to the received packet does not exist (No at St22), the L2SW chip 16 houses the packet into the packet buffer 15 (St23). Accordingly, the L2SW chip 16 may retain the packet until after it is determined by the packet determination unit 105 whether or not the packet is legal.

Next, in order to request the terminals Ta to Td and Txx for a MAC address corresponding to the transmission source IP address of the packet, the address requesting unit 104 generates an ARP request packet and transmits the ARP request packet from the pertaining one of the ports #1 to #4 (St24). Then, the packet determination unit 105 determines whether or not an ARP response packet to the ARP request packet is received (St25). At this time, the packet determination unit 105 detects, by a timer for example, reception of an ARP response packet within expiry time of the timer.

If an ARP response packet is not received (No at St25), the packet determination unit 105 determines that the received packet is an illegal packet (St31). Subsequently, the L2SW chip 16 discards the illegal packet (St32). At this time, the L2SW chip 16 clears the illegal packet housed in the packet buffer 15. The L2SW chip 16 does not perform MAC address learning based on the illegal packet and a transfer process of the illegal packet.

If an ARP response packet is received (Yes at St25), the packet determination unit 105 compares the search MAC address and the search IP address in the ARP response packet with the SA and the transmission source IP address of the packet housed already in the packet buffer 15, respectively (St26). If a result of the comparison indicates that the search MAC address and the search IP address in the ARP response packet do not coincide with the SA and the transmission source IP address of the packet, respectively (No at St26), the packet determination unit 105 determines that the received packet is an illegal packet (St31). Then, the L2SW chip 16 discards the received packet (St32).

If a result of the comparison indicates that the search MAC address and the search IP address in the ARP response packet coincide with the SA and the transmission source IP address of the packet, respectively (Yes at St26), the packet determination unit 105 determines that the received packet is a legal packet (St27). Then, the L2SW chip 16 registers the SA and the transmission source IP address of the received packet into the filter table 140 (St28).

Next, the L2SW chip 16 performs MAC address learning based on the received packet (St29) and transfers the received packet (St30). The operation in the restriction mode is performed in this manner.

In this manner, the packet determination unit 105 determines whether or not the SA that is the MAC address of the transmission source of a packet is legal based on an ARP response packet of the terminals Ta to Td and Txx to a request from the address requesting unit 104. The L2SW chip 16 discards or transfers the packet in response to a result of the determination by the packet determination unit 105.

Accordingly, the layer 2 switch 1 may detect and discard an illegal packet received from the terminal Txx of the malicious user. Therefore, the layer 2 switch 1 may defend against MAC flooding attacks without performing port closure. In the following, the process for a packet is described giving an example.

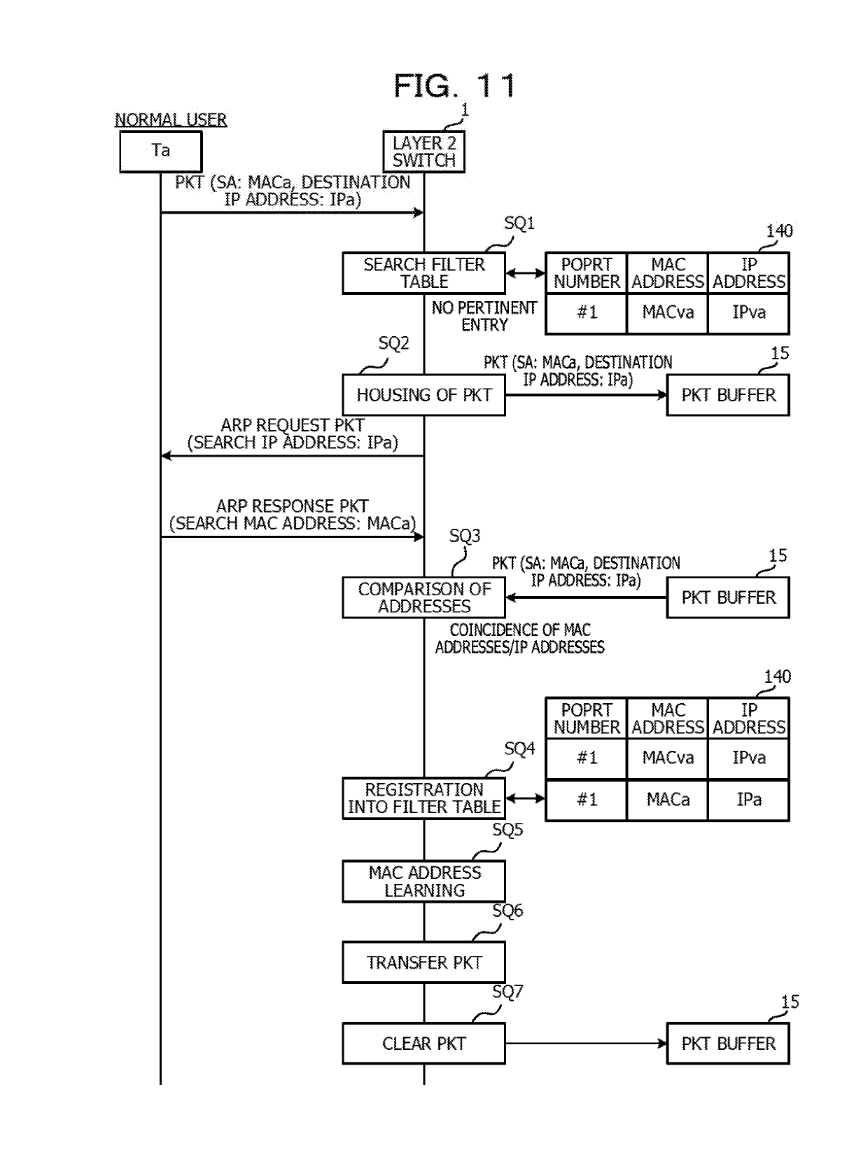

FIG. 11 is a sequence diagram illustrating an example of a process for a packet from a normal user. In the present example, a case is described in which the layer 2 switch 1 receives a packet having the legal SA “MACa” and the transmission source IP address “IPa” from the terminal Ta.

If the packet PKT is received from the terminal Ta through the port #1, the layer 2 switch 1 searches the filter table 140 (refer to symbol SQ1). It is assumed that, at this time, the filter table 140 does not include an entry pertinent to the received packet PKT.

Since no pertinent entry exists, the layer 2 switch 1 houses the received packet PKT into the packet buffer 15 (refer to symbol SQ2). The layer 2 switch 1 may house a different received packet having the same SA and transmission source IP address into the packet buffer 15 until a determination result is obtained by the packet determination unit 105.

Next, the layer 2 switch 1 transmits an ARP request packet in which the search IP address is the transmission source IP address “IPa” of the received packet to the terminal Ta. For example, the layer 2 switch 1 requests the terminal Ta for a MAC address corresponding to the transmission source IP address “IPa” of the received packet. Then, the layer 2 switch 1 receives an ARP response packet of the terminal Ta to the ARP request packet. It is assumed that the ARP response packet includes, as the search MAC address, the legal MAC address “MACa” of the terminal Ta.

Subsequently, the layer 2 switch 1 compares the search MAC address and the search IP address in the ARP response packet with the SA and the transmission source IP address of the received packet housed in the packet buffer 15, respectively (refer to symbol SQ3). Since the respective sets of a MAC address and an IP address coincide with each other, the layer 2 switch 1 registers the received packet into the filter table 140 (symbol SQ4). Consequently, entries of the port number “#1,” MAC address “MACa” and IP address “IPa” are added to the filter table 140.

Then, the layer 2 switch 1 performs MAC address learning based on the received packet (refer to symbol SQ5) and transfer of the received packet (refer to symbol SQ6). Then, the layer 2 switch 1 clears the received packet housed in the packet buffer 15 (refer to symbol SQ7). The process for a packet from a normal user is executed in this manner.

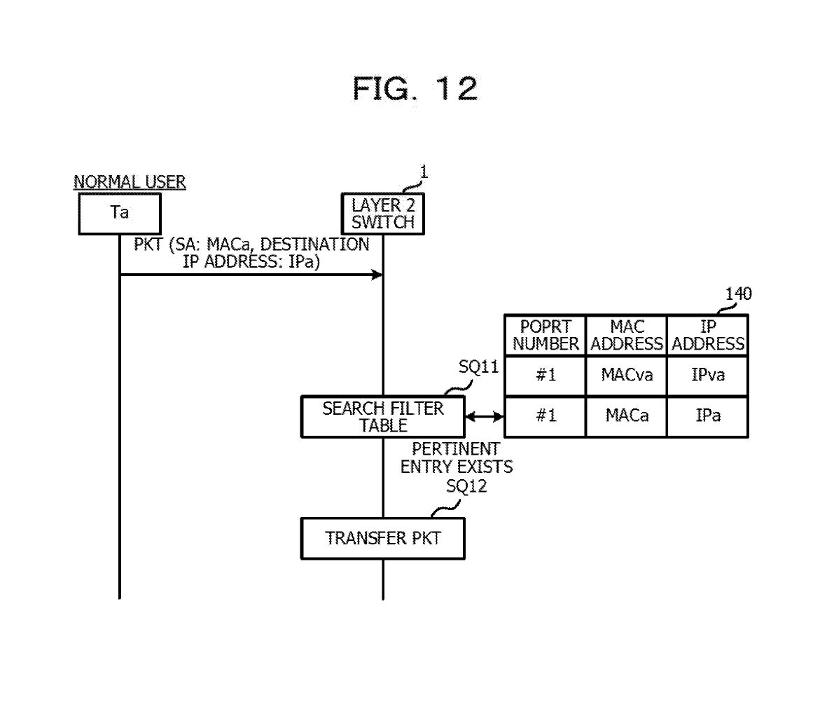

FIG. 12 is a sequence diagram illustrating another example of a process for a packet from a normal user. In the present example, a case in which, after the packet process illustrated in FIG. 11 is executed, a same packet is received from the same terminal Ta as that in the example of FIG. 11 is described.

If the layer 2 switch 1 receives the packet from the terminal Ta, it searches the filter table 140 (refer to symbol SQ11). At this time, into the filter table 140, the entries of the port number “#1,” MAC address “MACa” and IP address “IPa” have been registered already by the registration process SQ4 described hereinabove.

Since an entry pertinent to the received packet exists in the filter table 140, the layer 2 switch 1 regards the received packet as a legal packet without deciding whether or not the packet is legal and transfers the received packet (symbol SQ12). Since the MAC address of the received packet has been learned already by the MAC address learning SQ5 described above, MAC address learning based on the received packet is not performed. The process of a packet from a normal user is executed in this manner.

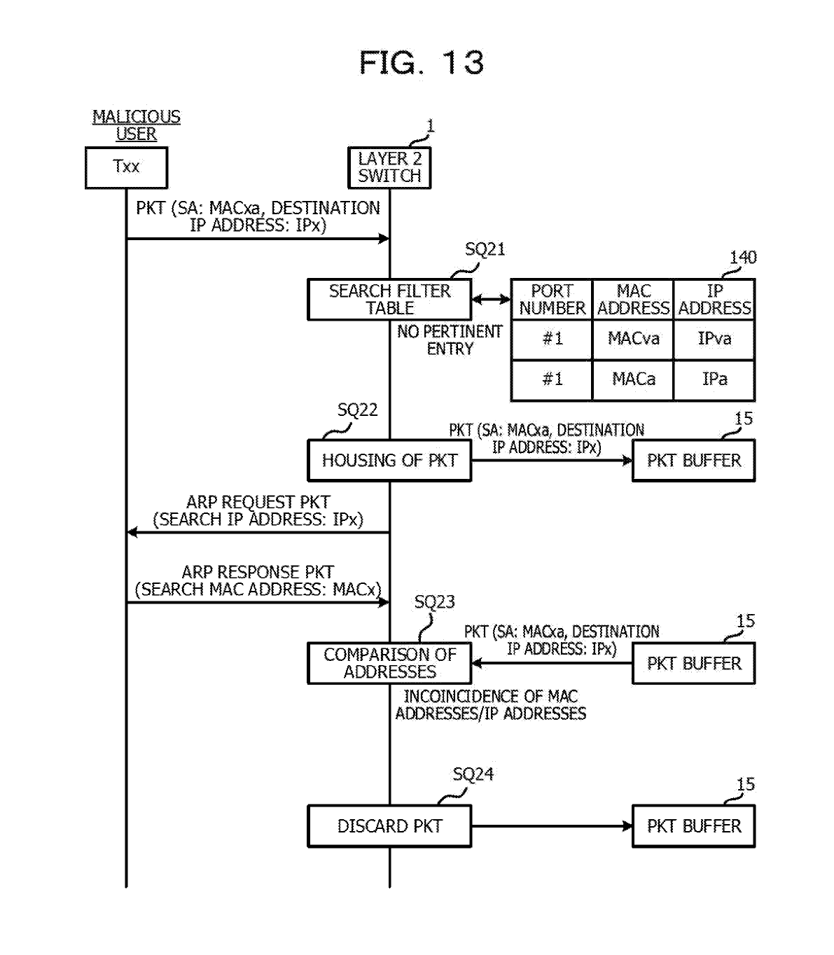

FIG. 13 is a sequence diagram illustrating an example of a process for a packet from a malicious user. In the present example, a case is described in which, after the packet process illustrated in FIG. 12 is performed, an illegal packet in which a false MAC address “MACxa” is used as the SA and the destination IP address is “IPx” is received from the terminal Txx of the malicious user.

If the packet PKT is received from the terminal Txx, the layer 2 switch 1 searches the filter table 140 (refer to symbol SQ21). At this time, an entry pertinent to the received packet PKT does not exist in the filter table 140. Accordingly, the layer 2 switch 1 houses the received packet PKT into the packet buffer 15 (refer to symbol SQ22).

Next, the layer 2 switch 1 transmits an ARP request packet in which the search IP address is the transmission source IP address “IPx” of the received packet to the terminal Txx. For example, the layer 2 switch 1 requests the terminal Txx for a MAC address corresponding to the transmission source IP address “IPx” of the received packet. Then, the layer 2 switch 1 receives an ARP response packet of the terminal Txx to the ARP request packet. It is assumed that the ARP response packet includes, as the search MAC address, the legal MAC address “MACx” of the terminal Txx.

Then, the layer 2 switch 1 compares the search MAC address and the search IP address in the ARP response packet with the SA and the transmission source IP address of the received packet housed in the packet buffer 15 (refer to symbol SQ23). At this time, since the SA of the received packet is a false MAC address, the respective sets of a MAC address and an IP address do not coincide with each other.

Therefore, the layer 2 switch 1 discards the received packet without registering the received packet into the filter table 140 (refer to symbol SQ24). At this time, the layer 2 switch 1 clears the received packet PKT housed in the packet buffer 15.

In this manner, when an illegal packet is received from the terminal Txx of the malicious user, the layer 2 switch 1 does not perform MAC address learning based on the illegal packet and does not transfer of the illegal packet. Accordingly, the layer 2 switch 1 may defend against MAC flooding attacks of the malicious user. At this time, since the layer 2 switch 1 does not perform port closure, communication of the other terminal Tb coupled to the same port #2 as that coupled to the terminal Txx is not cut.

As described above, the layer 2 switch 1 in the working example receives a packet from any of the terminals Ta to Td and Txx and transfers the packet. The layer 2 switch 1 includes a nonvolatile memory 14, an address requesting unit 104, a packet determination unit 105 and an L2SW chip 16.

The nonvolatile memory 14 stores MAC addresses and IP addresses in an associated relationship with each other. The address requesting unit 104 requests the terminals Ta to Td and Txx for a MAC address corresponding to the transmission source IP address of a packet. The packet determination unit 105 compares a MAC address indicated by an ARP response packet from any of the terminals Ta to Td and Txx to the request of the address requesting unit 104 with the SA of the packet. The packet determination unit 105 determines the legality of the correspondence relationship between the SA and the transmission source IP address of the packet in response to a result of the comparison.

The L2SW chip 16 stores the SA and the transmission source IP address of the packet into the nonvolatile memory 14 in response to a result of the determination of the packet determination unit 105. If a packet is newly received, the L2SW chip 16 compares the set of the SA and the transmission source IP address of the packet with the set of a MAC address and an IP address stored in the nonvolatile memory 14. Then, the L2SW chip 16 discards or transfers the packet in response to a result of the comparison.

According to the configuration described above, since the address requesting unit 104 requests the terminals Ta to Td and Txx for a MAC address corresponding to the transmission source IP address of a packet, the terminals Ta to Td and Txx return an ARP response packet not including a false MAC address but including a true MAC address. Since the packet determination unit 105 determines the legality of the correspondence relationship between the SA and the transmission source IP address of the packet based on the ARP response packet, an illegal packet may be detected based on the true MAC address of the terminals Ta to Td and Txx.

The L2SW chip 16 stores the SA and the transmission source IP address of the packet into the nonvolatile memory 14 in response to a result of the determination of the packet determination unit 105. If a packet is newly received, the L2SW chip 16 compares the set of the SA and the transmission source IP address of the packet with the set of a MAC address and an IP address stored in the nonvolatile memory 14. Then, the L2SW chip 16 discards or transfers the packet in response to a result of the comparison. Therefore, the layer 2 switch 1 may detect and discard an illegal packet received from the terminal Txx of the malicious user.

In this manner, the layer 2 switch 1 may defend against MAC flooding attacks without performing port closure.

A packet transfer method of the working example includes the following steps in a method of receiving a packet from the terminals Ta to Td and Txx and transferring the packet.

Step (1): a request for a MAC address corresponding to a transmission source IP address of a packet is issued to the terminals Ta to Td and Txx.

Step (2): a physical address indicated by a response from any of the terminals Ta to Td and Txx to the request and a SA of the packet are compared with each other.

Step (3): the legality of a correspondence relationship between the SA and the transmission source IP address of the packet is determined in response to a result of the comparison.

Step (4): the SA and the transmission source IP address of the packet are stored in an associated relationship with each other into the nonvolatile memory 14 in response to a result of the determination.

Step (5): when a packet is newly received, a set of the SA and the transmission source IP address of the packet is compared with a set of a MAC address and an IP address stored in the nonvolatile memory 14.

Step (6): the packet is discarded or transferred in response to a result of the comparison.

Since the packet transfer method of the working example includes a configuration similar to that of the layer 2 switch 1 described hereinabove, the packet transfer method exhibits working effects similar to those described hereinabove.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A packet transfer method executed by a processor included in a packet transfer apparatus that receives a packet from a terminal apparatus and transfers the packet, the packet transfer method comprising:
transmitting a request for providing a physical address corresponding to a logical address of a transmission source of the packet to the terminal apparatus;
determining legality of a correspondence relationship between the physical address of the transmission source and the logical address of the transmission source of the packet by comparing a physical address indicated by a response from the terminal apparatus with the physical address of the transmission source of the packet;
storing a first set of the physical address of the transmission source and the logical address of the transmission source of the packet, when it is determined that the correspondence relationship is legal;
when a new packet is received, determining whether a second set of a physical address of a transmission source and a logical address of the transmission source of the received new packet coincides with the first set; and
transferring the received new packet, when it is determined that the second set coincides with the first set.

2. The packet transfer method according to claim 1, further comprising
transmitting a request for providing a physical address corresponding to the logical address of the transmission source of the received new packet to the transmission source, when it is determined that the second set does not coincide with the first set.

3. The packet transfer method according to claim 1,
wherein the determining of the legality includes determining that the correspondence relationship is illegal, when the physical address indicated by the response from the terminal apparatus to the request and the physical address of the transmission source of the packet do not coincide with each other.

4. The packet transfer method according to claim 1,
wherein the determining of the legality includes determining that the correspondence relationship is illegal, when there is no response from the terminal apparatus to the request.

5. The packet transfer method according to claim 1,
wherein the transmitting includes transmitting a requesting packet configured to request the physical address corresponding to the logical address of the transmission source of the packet from all ports the packet transfer apparatus has.

6. The packet transfer method according to claim 1, further comprising:
storing, for each of a plurality of ports, physical address information in which an identifier of the port and a physical address of a transmission source included in a packet received by the port are associated with each other; and
determining whether a frequency of change of an identifier of a port housed in the physical address information and corresponding to the physical address of the transmission source of the packet exceeds a predetermined threshold value,
wherein the transmitting includes transmitting the request for providing a physical address corresponding to the logical address of the transmission source of the packet to the terminal apparatus, when it is determined that the frequency exceeds the predetermined threshold value.

7. The packet transfer method according to claim 6,
wherein the physical address information is updated when a packet is received from the transmission source and a port that has received the packet is different from the port corresponding to the physical address of the transmission source housed in the physical address information.

8. The packet transfer method according to claim 6, further comprising:
deleting the first set when it is determined that the frequency does not exceed the given threshold value and the physical address of the transmission source corresponding to the frequency is included in the first set.

9. The packet transfer method according to claim 6,
wherein the determining whether the frequency exceeds the predetermined threshold value includes determining, for each of the plurality of ports, whether the frequency exceeds the predetermined threshold value by periodically accessing to the physical address information.

10. A packet transfer apparatus that receives a packet from a terminal apparatus and transfers the packet, comprising:
a memory; and
a processor coupled to the memory and configured to:
transmit a request for providing a physical address corresponding to a logical address of a transmission source of the packet to the terminal apparatus;
determine legality of a correspondence relationship between the physical address of the transmission source and the logical address of the transmission source of the packet by comparing a physical address indicated by a response from the terminal apparatus with the physical address of the transmission source of the packet;
store a first set of the physical address of the transmission source and the logical address of the transmission source of the packet, when it is determined that the correspondence relationship is legal;
when a new packet is received, determine whether a second set of a physical address of a transmission source and a logical address of the transmission source of the received new packet coincides with the first set; and
transfer the received new packet, when it is determined that the second set coincides with the first set.

11. The packet transfer apparatus according to claim 10, wherein the processor is configured to
transmit a request for providing a physical address corresponding to the logical address of the transmission source of the received new packet to the transmission source, when it is determined that the second set does not coincide with the first set.

12. The packet transfer apparatus according to claim 10, wherein the processor is configured to
determine that the correspondence relationship is illegal, when the physical address indicated by the response from the terminal apparatus to the request and the physical address of the transmission source of the packet do not coincide with each other.

13. The packet transfer apparatus according to claim 10, wherein the processor is configured to
determine that the correspondence relationship is illegal, when there is no response from the terminal apparatus to the request.

14. The packet transfer apparatus according to claim 10, wherein the processor is configured to
transmit a requesting packet configured to request the physical address corresponding to the logical address of the transmission source of the packet from all ports the packet transfer apparatus has.
